(19) United States
(12) Patent Application Publication
(10) Pub. No.: US 2014/0139779 A1
(43) Pub. Date: May 22, 2014

(54) Backlight Module and Liquid Crystal Display Device

(71) Applicant: Shenzhen China Star Optoelectronics Co. Ltd, Shenzhen, Guangdong (CN)

(72) Inventor: Zexin Wu, Shenzhen (CN)

(73) Assignee: Shenzhen China Star Optoelectronics Technology Co., Ltd., Shenzhen, Guangdong (CN)

(21) Appl. No.: 13/702,295

(22) PCT Filed: Nov. 29, 2012
(86) PCT No.: PCT/CN12/85499

§ 371 Date: Dec. 5, 2012

(30) Foreign Application Priority Data
Nov. 22, 2012 (CN) 201210478883.8

(51) Int. Cl. F21V 29/00; G02F 1/1333

(52) U.S. Cl. CPC F21V 29/004; G02F 1/133382
USPC 349/58; 362/97.1

(57) ABSTRACT

The present invention discloses a backlight module and a liquid crystal display device. The backlight module comprises a backplane, a heat source, and a heat block mechanism. The heat source is fixed corresponding to the backplane. The heat block mechanism is provided on the way of heat transmission between the backplane and the heat source, which blocks the heat from the heat source transmitted to the backplane. Through the above-described manner, this present invention provides the heat block mechanism on the way of heat transmission between the heat source and the liquid crystal panel, which blocks the heat from the heat source transmitted to the backplane and decreases the uneven brightness resulted from the overheated liquid crystal panel.

### 1. FIELD OF THE INVENTION

The present invention relates to the technical field of a liquid crystal display, and in particular to a backlight module and a liquid crystal display device.

### 2. THE RELATED ARTS

In the present technology, the structure of the liquid crystal display device usually is shown as FIG. 1. The liquid crystal display device 100 comprises a liquid crystal panel 110, a plastic frame 120 and a backlight module 130. Wherein, the plastic frame 120 is provided between the liquid crystal panel 110 and the backlight module 130. The backlight module 130 comprises a backplane 134, a LED 131, a aluminum extrusion 133 and a metal core printed circuit board (MCPCB) 132. Wherein, one part of the aluminum extrusion 133 is provided between the side plate of the backplane 134 and the MCPCB 132 and directly contacts with the inner surface of the side plate of the backplane 134 and the MCPCB 132. The plastic frame 120 directly contacts with the exterior surface of the side plate of the backplane 134.

Heat generated from the LED 131 emitting light will transmit to the aluminum extrusion 133 through the MCPCB 132 and then to the backplane 134. Because the plastic frame 120 contacts with the liquid crystal panel 110 and the backplane 134 of the backlight module 130 respectively, a part of heat generated from the LED 130 transmits to the liquid crystal panel 10 through the plastic frame 120. While the liquid crystal panel 110 is overheated, it is easy to cause the uneven brightness of the liquid crystal panel 110.

### SUMMARY OF THE INVENTION

The technical issue to be solved by the present invention is to provide a backlight module and a liquid crystal display device, which can block the heat generated from the heat source transmitted to the liquid crystal panel and decrease the uneven brightness of the liquid crystal panel.

To solve the above technical issue, the present invention provides a backlight module, comprising a backplane, a heat source, a heat conductor, a heat block mechanism; the backplane comprising a bottom plate and a side plate which is laterally bended up from the bottom plate; the heat source being a light source, which is provided adjacent to the side plate of the backplane; one part of the heat conductor being between the light source and the side plate of the backplane, and the other part being thermally coupled with the bottom plate of the backplane; the light source being thermally coupled with the heat conductor; a 0.5˜4-millimeter gap provided between the heat conductor and the side plate of the backplane to form the heat block mechanism, which blocks heat from the heat source transmitted to the backplane; the heat block mechanism further comprising a disconnected portion at a bend between the side plate of the backplane and the bottom plate; the disconnected portion provided corresponding to the position of the light source; and a reinforced mechanism provided adjacent to the disconnected portion at the bend between the side plate of the backplane and the bottom plate.

To solve the above technical issue, the present invention provides a backlight module, comprising a backplane, a heat source, and a heat block mechanism; the heat source fixed corresponding to the backplane; the heat block mechanism provided on the way of heat transmission between the backplane and the heat source, which blocks the heat from the heat source transmitted to the backplane.

Wherein, the backlight module comprises a heat conductor; the backplane comprises a bottom plate and a side plate which is laterally bended up from the bottom plate; the heat source is a light source, which is provided adjacent to the side plate of the backplane; one part of the heat conductor is between the light source and the side plate of the backplane, and the other part is thermally coupled with the bottom plate of the backplane; the light source is thermally coupled with the heat conductor; a gap is provided between the heat conductor and the side plate of the backplane to form the heat block mechanism.

Wherein, the size of the gap is 0.5˜4 millimeters.

Wherein, the heat block mechanism comprises a disconnected portion at a bend between the side plate of the backplane and the bottom plate, and the disconnected portion is provided corresponding to the position of the light source.

Wherein, a reinforced mechanism is provided adjacent to the disconnected portion at the bend between the side plate of the backplane and the bottom plate.

Wherein, the reinforced mechanism is a rib provided at the bend between the side plate of the backplane and the bottom plate.

To solve the above technical issue, the present invention further provides a liquid crystal display device, comprising a liquid crystal panel, an intermediate frame, a backlight module and a heat block mechanism; the intermediate frame provided between the liquid crystal panel and the backlight module; the backlight module comprising a backplane and a heat source; the heat source fixed corresponding to the backplane; the heat block mechanism provided on the way of heat transmission between the backplane and the heat source, which blocks the heat from the heat source transmitted to the backplane.

Wherein, the backlight module comprises a heat conductor; the backplane comprises a bottom plate and a side plate which is laterally bended up from the bottom plate; the heat conductor and the side plate of the backplane are provided on the way of heat transmission between the liquid crystal panel and the heat source; the heat source is a light source, which is provided adjacent to the side plate of the backplane; one part of the heat conductor is between the light source and the side plate of the backplane, and the other part is thermally coupled with the bottom plate of the backplane; the light source is thermally coupled with the heat conductor; a gap is provided between the heat conductor and the side plate of the backplane to form the heat block mechanism.

Wherein, the heat block mechanism comprises the disconnected portion at a bend between the side plate of the backplane and the bottom plate, and the disconnected portion is provided corresponding to the position of the light source.

Wherein, a reinforced mechanism is provided adjacent to the disconnected portion at the bend between the side plate of the backplane and the bottom plate.

The beneficial effects of the present invention distinguishing from the present technology is that the present invention provides the heat block mechanism on the way of heat transmission between the heat source and the liquid crystal panel, which blocks the heat from the heat source transmitted to the liquid crystal panel and decreases the uneven brightness resulted from the overheated liquid crystal panel.

### BRIEF DESCRIPTION OF THE DRAWINGS

FIG. 1 is a schematic view illustrating the partial structure of a known liquid crystal display device;

FIG. 2 is a schematic view illustrating the partial structure of the liquid crystal display device of one embodiment according to the present invention;

FIG. 3 is a schematic view illustrating the partial structure of the liquid crystal display device of another embodiment according to the present invention;

FIG. 4 is a schematic perspective view illustrating the backplane in FIG. 3; and

FIG. 5 is a schematic view illustrating the partial structure of the backlight module of one embodiment according to the present invention.

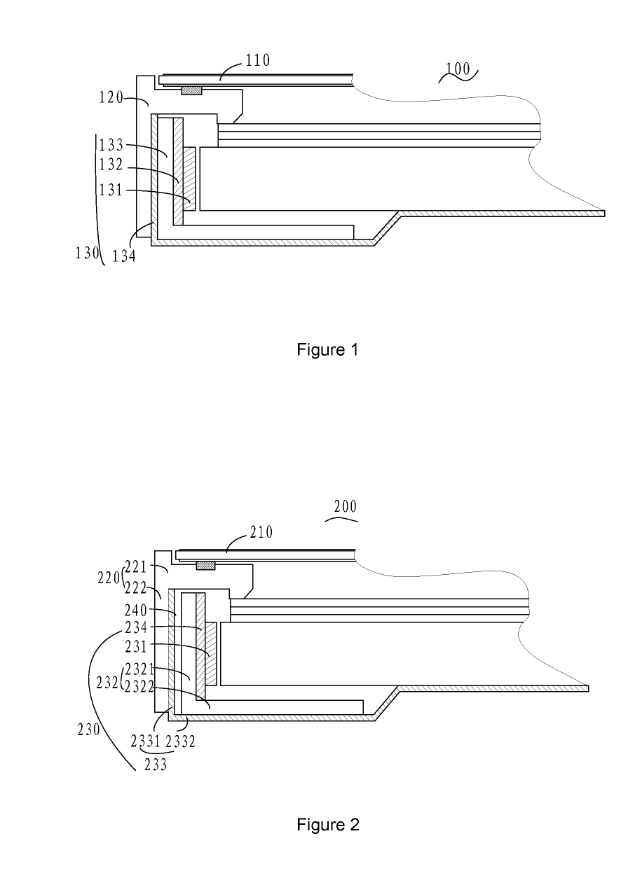

### DETAILED DESCRIPTION OF THE PREFERRED EMBODIMENTS

The detailed descriptions accompanying drawings and the preferred embodiment of the present invention are as follows.

Referring to FIG. 2, it is a schematic view illustrating the partial structure of a liquid crystal display device of one embodiment according to the present invention. In the present embodiment, the liquid crystal display device 200 comprises: a liquid crystal panel 210, an intermediate frame 220, a backlight module 230 and the heat block mechanism 240.

The intermediate frame 220 comprises a rectangle frame body 221 with the opening window in the center and a first side plate 222 which is extended downward from the outer side of the rectangle frame body 221. The backlight module 230 comprises a light source 231, a heat conductor 232, a backplane 233, and a MCPCB 234. The backplane 233 comprises a first bottom plate 2332 and a second side plate 2331 which is bended upward from the outer side of the bottom plate 2332. The heat conductor 232 comprises a second bottom plate 2322 and a third side plate 2321 which is extended upward from one side of the second side plate 2322.

Wherein, the second bottom plate 2322 of the heat conductor 232 attaches to the surface of the first bottom plate 2332 of the backplane 233 and couples with the first bottom plate 2332 to form a thermal-coupled structure. The third side plate 2321 of the heat conductor 232 is provided adjacent to the second side plate 2331 of the backplane 233. The heat source 231 is fixed corresponding to the backplane 233, which is provided adjacent to the second side plate 2331. Specifically, the third side plate 2321 of the heat conductor 232 is provided between the light source 231 and the second side plate 2331 of the backplane 233, and at the horizontal side of the MCPCB 234. The light source 231 is fixed at the other side of the MCPCB 234 and against one side of the second side plate 2331 of the backplane 233, which makes the light source 231 couple with the heat conductor 232 to form the thermal coupled structure. Furthermore, the rectangle frame body 221 of the intermediate frame 220 is provided on the second side plate 2331 of the backplane 233. The first side plate 222 is provided at the horizontal outer side of the second side plate 2331 of the backplane 233.

The heat block mechanism 240 is provided on the way of heat transmission between the backplane 233 and the heat conductor 232, which blocks the heat from the heat source 231 transmitted to the backplane 233. In the present embodiment, a gap is provided between the heat conductor 232 and the second side plate 2331 to form the heat block mechanism 240.

The specific description for the heat block mechanism 240 is as follows. The light source 231 emits light and generates heat, which forms the heat source. Because the light source 231 couples with the heat conductor 232 to form the thermal-coupled structure, the light source 231 transmits partial heat to the heat conductor 232. Because a gap is provided between the heat conductor 232 and the second side plate 2331, the air within the gap is regarded as the no flowing one while the distance of the gap is shorter than the temperature boundary layer. At this moment, the air within the gap has no effect of the heat transmission but the function of the heat conduction. Due the smaller heat conductivity in the air, at this time, the air within the gap only has the effect of heat insulation, that is, it blocks heat transmitted from the heat conductor 232 to the second side plate 2331. Furthermore, the above gap blocks the heat generated from the light source 231 transmitted to the liquid crystal panel 210 and decreases the uneven brightness resulted from the overheated liquid crystal panel 210. In other words, the gap between the heat conductor 232 and the second side plate 2331 forms the heat block mechanism 240.

In the present embodiment, the distance between the heat conductor 232 and the second side plate 2331 is 0.5˜4 millimeters, such as 1 millimeter, 2 millimeters, 3 millimeters and so on. The distance of the gap is not limited in 0.5˜4 millimeters. In the specific embodiment, based on the actual situation, the technical personnel can choose the better distance of the gap for blocking heat as the gap distance. In order to describe conveniently, the intermediate frame in the article is provided at the outer side of the backlight module, but it is not supposed to be limited. In another embodiment, the intermediate frame can also be provided in the center of the backlight module.

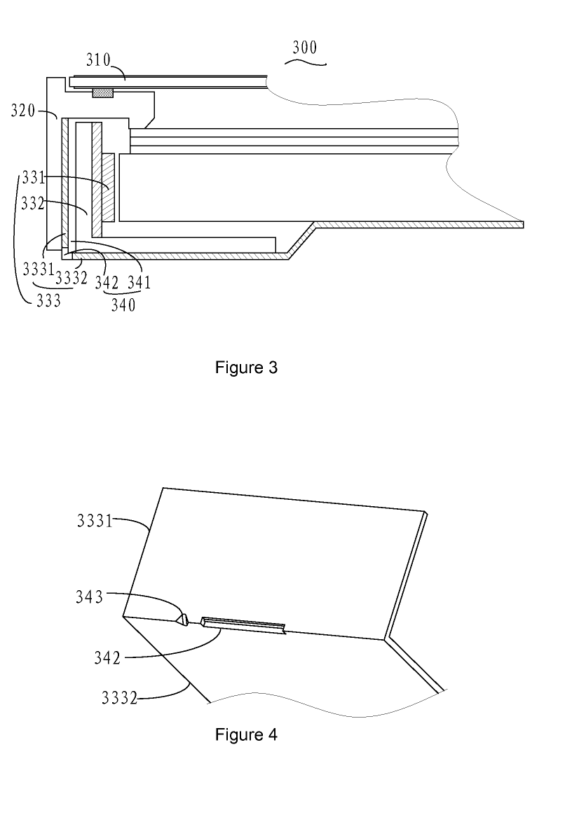

Referring to FIG. 3 and FIG. 4, FIG. 3 is a schematic view illustrating the partial structure of the liquid crystal display device of another embodiment according to the present invention, and FIG. 4 is a schematic perspective view illustrating the backplane in FIG. 3. In order to achieve the better heat insulation, the present embodiment provides even better one. The present embodiment is based on the previous one and is further optimized. It is not to be repeated about the structure of the liquid crystal display device 300 because it is the same as the previous embodiment. If necessary, please refer to the description in the previous embodiment.

Comparing with the previous embodiment, it is optimized that the heat block mechanism 340 according to the present embodiment comprises a gap 341 provided between the heat conductor 332 and the second side plate 3331 of the backplane 333, and a disconnected portion 342 at a bend between the second side plate 3331 of the backplane 333 and the first bottom plate 3332. In the present embodiment, in order to get the better effect of heat insulation, the position of the disconnected portion 342 is corresponding to the position of the light source 331.

The further descriptions for the heat block mechanism 340 are as follow. In the above embodiment, the heat insulation principle of the gap 341 has been described. Referring to the related description of the above embodiment, the light source 331 emits light and generates heat which is transmitted to the heat conductor 332 thermally coupled with the same. The gap 341 blocks the heat transmitted from the heat conductor 332 to the second side plate 3331 of the backplane 333, which blocks partial heat generated from the light source 331 transmitted directly to the liquid crystal panel 310. However, on the other hand, because the heat conductor 332 thermally couples with the first bottom plate 3332 of the backplane 333, the heat of the heat conductor 332 will be transmitted to the second side plate 3331 through the first bottom plate 3332 and then to the liquid crystal panel 310 through the intermediate frame 320. In the present embodiment, the disconnected portion 342 at the bend between the second side plate 3331 of the backplane 333 and the first bottom plate 3332 blocks the heat transmitted from the first bottom plate 3332 to the second side plate 3331, which further blocks the heat generated from the light source 331 transmitted to the liquid crystal panel 310.

To make it better, the present embodiment provides a reinforced mechanism 343 adjacent to the disconnected portion 342 at the bend between the second side plate 3331 and the first bottom plate 3332. The reinforced mechanism 343 decreases the effect that the disconnected portion 342 weakens the strength of the backplane 333.

It has been described previously that the present embodiment provides the disconnected portion 342 at the bend between the second side plate 3331 of the backplane 333 and the first bottom plate 3332 in order to achieve the better heat insulation. However, the disconnected portion provided at the connection between the second side plate 3331 and the first bottom plate 3332 causes a certain effect on the strength of the backplane 333. To decrease the above effect, the reinforced mechanism 343 is provided adjacent to the disconnected portion 342 at the bend between the second side plate 3331 and the first bottom plate 3332. Specifically, the present embodiment provides a rib (the shape of the back is groove) adjacent to the disconnected portion 342 at the bend between the second side plate 3331 and the first bottom plate 3332 and adjacent to one side of the heat conductor 332 to achieve reinforcement. In another embodiment, the reinforced mechanism 343 can also be achieved by the other reinforced ways and not be limited in the rib (the shape of the back is groove) provided adjacent to the disconnected portion 342 at the bend between the second side plate 3331 and the first bottom plate 3332.

The present invention provides the heat block mechanism between the heat conductor and the backplane, which blocks the heat generated from the light source transmitted to the liquid crystal panel and decreases the uneven brightness resulted from the overheated liquid crystal. To make it better, the present invention provides the reinforced mechanism, which is adjacent to the disconnected portion at the bend between the second side plate and the first bottom plate. Meanwhile, the reinforced mechanism can not only improve heat insulation, but also decrease the bad effects on the strength of the backplane.

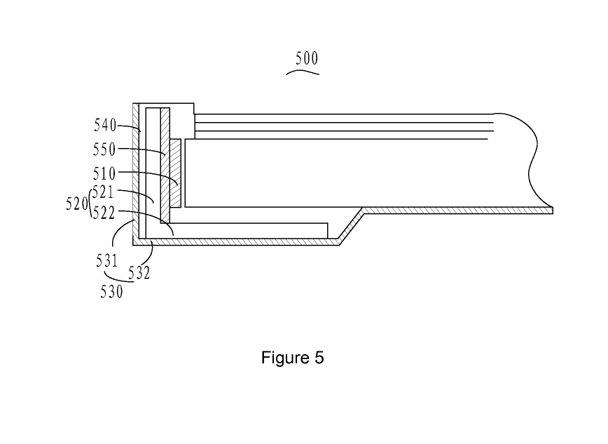

Referring to FIG. 5, it is a schematic view illustrating the partial structure of the backlight module of one embodiment according to the present invention. The backlight module 500 according to the present embodiment comprises: a light source 510, a heat conductor 520, a backplane 530, a MCPCB 550, and a heat block mechanism 540. The backplane 530 comprises a first bottom plate 532 and the outer side of a second side plate 531 which is bended upward from the first bottom plate 532. The heat conductor 520 comprises a second side plate 522 and one side of a third side plate 521 which extends upward from the second bottom plate 522.

Wherein, the second bottom plate 522 of the heat conductor 520 attaches to the upper surface of the first bottom plate 532 of the backplane 530 and couples with the first bottom plate 532 to form the thermal-coupled structure. The third side plate 521 of the heat conductor 520 is provided adjacent to the second side plate 531 of the backplane 530. The heat source 510 is fixed corresponding to the backplane 530, which is provided adjacent to the second side plate 531. Specifically, the third side plate 521 of the heat conductor 520 is provided between the light source 510 and the second side plate 531 of the backplane 530, and at the horizontal side of the MCPCB 550. The light source 510 is fixed at the other side of the MCPCB 550 and against one side of the second side plate 531 of the backplane 530, which makes the light source 510 couple with the heat conductor 520 to form the thermal coupled structure.

The heat block mechanism 540 is provided on the way of heat transmission between the backplane 530 and the heat conductor 520, which blocks the heat from the heat source 510 transmitted to the backplane 530. In the present embodiment, a gap is provided between the heat conductor 520 and the second side plate 531 to form the heat block mechanism 540.

The specific descriptions for the heat block mechanism 540 referring to FIG. 2 and FIG. 5. The light source 510 emits light and generates heat, which forms the heat source. Because the light source 510 couples with the heat conductor 520 to form the thermal-coupled structure, the light source 510 transmits partial heat to the heat conductor 520. Because a gap is provided between the heat conductor 520 and the second side plate 531, the air within the gap is regarded as the no flowing one while the distance of the gap is shorter than the temperature boundary layer. At this moment, the air within the gap has no effect of the heat transmission but the function of the heat conduction. Due the smaller heat conductivity in the air, at this time, the air within the gap only has the effect of heat insulation, that is, it blocks heat transmitted from the heat conductor 520 to the second side plate 531. In other words, the gap between the heat conductor 520 and the second side plate 531 forms the heat block mechanism 540. In FIG. 2, it can be known that the intermediate frame thermally couples with the second side plate 531 and the liquid crystal panel in the liquid crystal display device, the heat block mechanism 540 blocks the heat transmitted from the heat conductor 520 to the second side plate 531. Furthermore, the heat block mechanism 540 blocks the heat generated from the light source 510 transmitted to the liquid crystal panel.

In the present embodiment, the distance between the heat conductor 520 and the second side plate 531 is 0.5˜4 millimeters, such as 1 millimeter, 2 millimeters, 3 millimeters and so on. The distance of the gap is not limited in 0.5˜4 millimeters. In the specific embodiment, based on the actual situation, the technical personnel can choose the better distance of the gap for blocking heat as the gap distance. At the same time, the intermediate frame is not provided in the backlight module 500, but it is not supposed that the backlight module 500 according to the present invention does not comprise the intermediate frame. In another embodiment, the intermediate frame can also be provided in the center of the backlight module 500.

Referring to FIG. 3 and FIG. 5, to achieve the better heat insulation, the present embodiment provides the better embodiment of the backlight module. The present embodiment is based on the previous one and is further optimized. It is not to be repeated about the structure of the backlight module 500 because it is the same as the previous embodiment. If necessary, please refer to the description in the previous embodiment.

Comparing with the previous embodiment, it is optimized that the heat block mechanism 540 according to the present embodiment comprises a gap provided between the heat conductor 520 and the second side plate 531, and a disconnected portion at the bend between the second side plate 531 of the backplane 530 and the first bottom plate 532. In the present embodiment, in order to get the better effect of heat insulation, the position of the disconnected portion at the bend between the second side plate 531 of the backplane 530 and the first bottom plate 532 is corresponding to the position of the light source 510.

The further descriptions for the heat block mechanism 540 are as follow. In the above embodiment, the heat insulation principle of the gap between the heat conductor 520 and the second side plate 531 has been described. Referring to the related description of the above embodiment, the light source 510 emits light and generates heat which is transmitted to the heat conductor 520 thermally coupled with the same. The gap between the heat conductor 520 and the second side plate 531 blocks the heat transmitted from the heat conductor 520 to the second side plate 531. However, on the other hand, because the heat conductor 520 thermally couples with the first bottom plate 532, the heat of the heat conductor 520 will be transmitted to the second side plate 531 through the first bottom plate 532. In the present embodiment, the disconnected portion at the bend between the second side plate 531 and the first bottom plate 532 blocks the heat transmitted from the first bottom plate 532 to the second side plate 531, which further blocks the heat generated from the light source 510 transmitted to the second side plate 531.

To make it better, the present embodiment provides a reinforced mechanism adjacent to the disconnected portion at the bend between the second side plate 531 and the first bottom plate 532. The reinforced mechanism decreases the effect that the disconnected portion weakens the strength of the backplane 530.

It has been described previously that the present embodiment provides the disconnected portion at the bend between the second side plate 531 and the first bottom plate 532 in order to achieve the better heat insulation. However, the disconnected portion provided at the connection between the second side plate 531 and the first bottom plate 532 causes a certain effect on the strength of the backplane 530. To decrease the above effect, the reinforced mechanism is provided adjacent to the disconnected portion at the bend between the second side plate 531 and the first bottom plate 532. Specifically, the present embodiment provides a rib (the shape of the back is groove) adjacent to the disconnected portion at the bend between the second side plate 531 and the first bottom plate 532 and adjacent to one side of the heat conductor 332 to achieve reinforcement. In another embodiment, the reinforced mechanism can also be achieved by the other reinforced ways and not be limited in the rib (the shape of the back is groove) provided adjacent to the disconnected portion at the bend between the second side plate 531 and the first bottom plate 532.

The present invention provides the heat block mechanism between the heat conductor and the backplane, which blocks the heat generated from the light source transmitted to the second side plate and then transmitted to the liquid crystal panel of the liquid crystal display device, which is corresponding to the backlight module, through the intermediate frame, which decreases the uneven brightness resulted from the overheated liquid crystal. To make it better, the present invention provides the reinforced mechanism adjacent to the disconnected portion at the bend between the second side plate and the first bottom plate. Meanwhile, the reinforced mechanism can not only improve heat insulation, but also decrease the bad effects on the strength of the backplane.

The preferred embodiments according to the present invention are mentioned above, which cannot be used to define the scope of the right of the present invention. Those modifications and variations are considered encompassed in the scope of protection defined by the claims of the present invention.

What is claimed is:

1. A backlight module, comprising a backplane, a heat source, a heat conductor, a heat block mechanism; the backplane comprising a bottom plate and a side plate which is laterally bended up from the bottom plate; the heat source being a light source, which is provided adjacent to the side plate of the backplane; one part of the heat conductor being between the light source and the side plate of the backplane, and the other part being thermally coupled with the bottom plate of the backplane; the light source being thermally coupled with the heat conductor; a 0.5˜4-millimeter gap provided between the heat conductor and the side plate of the backplane to form the heat block mechanism, which blocks heat from the heat source transmitted to the backplane; the heat block mechanism further comprising a disconnected portion at a bend between the side plate of the backplane and the bottom plate; the disconnected portion provided corresponding to the position of the light source; and a reinforced mechanism provided adjacent to the disconnected portion at the bend between the side plate of the backplane and the bottom plate.

2. A backlight module, comprising a backplane, a heat source, and a heat block mechanism; the heat source fixed corresponding to the backplane; the heat block mechanism provided on the way of heat transmission between the backplane and the heat source, which blocks the heat from the heat source transmitted to the backplane.

3. The backlight module as claimed in claim 2, wherein the backlight module comprises a heat conductor; the backplane comprises a bottom plate and a side plate which is laterally bended up from the bottom plate; the heat source is a light source, which is provided adjacent to the side plate of the backplane; one part of the heat conductor is between the light source and the side plate of the backplane, and the other part is thermally coupled with the bottom plate of the backplane; the light source is thermally coupled with the heat conductor; a gap is provided between the heat conductor and the side plate of the backplane to form the heat block mechanism.

4. The backlight module as claimed in claim 3, wherein the size of the gap is 0.5˜4 millimeters.

5. The backlight module as claimed in claim 3, wherein the heat block mechanism comprises a disconnected portion at a bend between the side plate of the backplane and the bottom plate, and the disconnected portion is provided corresponding to the position of the light source.

6. The backlight module as claimed in claim 5, wherein a reinforced mechanism is provided adjacent to the disconnected portion at the bend between the side plate of the backplane and the bottom plate.

7. The backlight module as claimed in claim 6, wherein the reinforced mechanism is a rib provided at the bend between the side plate of the backplane and the bottom plate.

8. A liquid crystal display device, comprising a liquid crystal panel, an intermediate frame, a backlight module and a heat block mechanism; the intermediate frame provided between the liquid crystal panel and the backlight module; the backlight module comprising a backplane and a heat source; the heat source fixed corresponding to the backplane; the heat block mechanism provided on the way of heat transmission between the backplane and the heat source, which blocks the heat from the heat source transmitted to the backplane.

9. The liquid crystal display device as claimed in claim 8, wherein the backlight module comprises a heat conductor; the backplane comprises a bottom plate and a side plate which is laterally bended up from the bottom plate; the heat conductor and the side plate of the backplane are provided on the way of heat transmission between the liquid crystal panel and the heat source; the heat source is a light source, which is provided adjacent to the side plate of the backplane; one part of the heat conductor is between the light source and the side plate of the backplane, and the other part is thermally coupled with the bottom plate of the backplane; the light source is thermally coupled with the heat conductor; a gap is provided between the heat conductor and the side plate of the backplane to form the heat block mechanism.

10. The liquid crystal display device as claimed in claim 9, wherein the heat block mechanism comprises a disconnected portion at a bend between the side plate of the backplane and the bottom plate, and the disconnected portion is provided corresponding to the position of the light source.

11. The liquid crystal display device as claimed in claim 10, wherein a reinforced mechanism is provided adjacent to the disconnected portion at the bend between the side plate of the backplane and the bottom plate.
